(19) United States
(12) Patent Application Publication
(10) Pub. No.: US 2026/0042948 A1
(43) Pub. Date: Feb. 12, 2026

(54) SURFACTANT COMPOSITION FOR DIRECT EMULSION DRILLING FLUID

(71) Applicant: Schlumberger Technology Corporation, Sugar Land, TX (US)

(72) Inventors: Dimitri Khramov, Katy, TX (US); Jeremy Smith, Houston, TX (US)

(21) Appl. No.: 18/800,896

(22) Filed: Aug. 12, 2024

(51) Int. Cl. C09K 8/28; C09K 8/60

(52) U.S. Cl. CPC C09K 8/28; C09K 8/602

(57) ABSTRACT

The present disclosure provides drilling fluids and methods thereof. The drilling fluids include an emulsion. The emulsion includes an aqueous phase, an oil, and a surfactant composition. The surfactant composition includes an alkyl ether anion surfactant including an oleth carboxylate. The surfactant composition includes an organic acid including a carboxylic acid.

### FIELD

This application relates to stable emulsions used as drilling fluids. More specifically, this application relates to methods and compositions for stabilizing oil-in-water emulsions in drilling geologic formations.

### BACKGROUND

Direct emulsion, oil-in-water, drilling fluids are generally used in salt formations or for the entire length of a well, e.g., from the surface through the vertical sections to the lateral sections. The external phase of a direct emulsion is an aqueous phase, which can be pure water or an aqueous salt solution of various concentrations. A direct emulsion with an aqueous salt solution as the external phase has decreased density compared to pure salt brine. Saturated salt brine, such as NaCl, is used when drilling through salt formations because saturated brine does not dissolve salt from the formation, reducing or eliminating formation damage when the formation contains a lot of salt. While using an inverted emulsion (water-in-oil) can decrease density of the drilling fluid further, invert emulsion systems are less tolerant to formations where large water influxes are expected.

Because of high salinity and presence of polyvalent cations, many surfactants that form direct oil-in-water emulsions are not suitable for use with salt containing formations. Direct emulsion-based drilling fluids are expected to remain water continuous from temperatures at or below the freezing temperature of water up to about 150-200° F. (expected downhole temperature), and are expected to be able to function despite large influxes of water or salt water. Unfortunately, many surfactants used in direct emulsion-based drilling fluids are unable to remain water continuous from temperatures at or below the freezing temperature of water.

Previous attempts at reducing pour points have focused on introducing solvents such as aromatic solvents. Unfortunately, introducing solvents results in a dilution of the surfactant, thereby increasing the manufacturing and transportation costs. Other attempts at reducing pour points have focused on introducing alcohols. However, destabilization of the direct emulsion-based drilling fluid, and degradation of the surfactant, occurs when treating the mud with “economically viable” amounts. Additionally, conventional alcohols and carboxylic acids can self-esterify, in storage, thereby reducing performance of the surfactant, and thus the direct emulsion-based drilling fluid.

Accordingly, there is a need for improved direct emulsion drilling fluids.

### SUMMARY

In an embodiment, the present disclosure provides drilling fluids. The drilling fluids include an emulsion. The emulsion includes an aqueous phase, an oil, and a surfactant composition. The surfactant composition includes an alkyl ether anion surfactant including an oleth carboxylate. The surfactant composition includes an organic acid including a carboxylic acid.

In another embodiment, the present disclosure provides surfactant compositions. The surfactant compositions include an alkyl ether anion surfactant including an oleth carboxylate. The surfactant composition includes an organic acid composition including an organic acid represented by Formula (I)

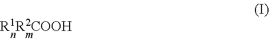

wherein R¹ is selected from the group consisting of a substituted C₁-C₈ alkyl, an unsubstituted C₁-C₈ alkyl, a substituted C₁-C₈ alkylene, an unsubstituted C₁-C₈ alkylene, substituted C₁-C₈ alkynl, an unsubstituted C₁-C₈ alkynl, substituted C₁-C₈ alkynlene, an unsubstituted C₁-C₈ alkynlene, substituted C₁-C₈ aryl, an unsubstituted C₁-C₈ aryl, a substituted C₁-C₈ alkoxy, an unsubstituted C₁-C₈ alkoxy, and combinations thereof; R² is an C₁-C₃ alkoxy; n is an integer of 1 to 5; and m is an integer of 0 to 5.

In another embodiment, the present disclosure provides methods. The methods include obtaining a drilling fluid including an emulsion of an oil dispersed within an aqueous phase. The emulsion is stabilized using a surfactant composition including an alkyl ether anion surfactant and an organic acid composition. A well is drilled into a geologic formation using the drilling fluid from a surface of the well through vertical sections and into lateral sections.

### BRIEF DESCRIPTION OF THE DRAWINGS

FIG. 1 shows schematic liquid volume diagram of a plurality of direct emulsion drilling fluids having varying organic acids, according to embodiments of the present disclosure.

FIG. 2 shows a schematic liquid volume diagram of a plurality of direct emulsion drilling fluids after a rolling process, according to embodiments of the present disclosure.

FIG. 3 shows a schematic liquid volume diagram of a direct emulsion fluid after separation, according to embodiments of the present disclosure.

FIG. 4 shows a schematic liquid volume diagram of a plurality of direct emulsion drilling fluids after a rolling process, according to embodiments of the present disclosure illustrating an unstable emulsion.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific, it is to be understood that inventors appreciate and understand that any data points within the range are to be considered to have been specified, and that inventors possessed knowledge of the entire range and the points within the range.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Described herein are direct emulsion drilling fluids having a surfactant composition including an organic acid composition. The drilling fluids can be suitable for wellbores including salt-containing components. The organic acid composition reduces the pour point of the direct emulsion drilling fluids down to about −15° C. without destabilizing the emulsion and without creating objectionable odors or introducing aromatic solvents. Moreover, the stability of the direct emulsion drilling fluid may be maintained for a period of about 6 hours to about 48 hours or more, e.g., about 96 hours, about 128 hours, or about 1,000 hours. The organic acid composition is added to the surfactant composition at ratios of about 50:50 to about 95:5 of an alkyl ether anion surfactant to the organic acid composition, thereby having minimal organic acid concentration such that a decrease in the manufacturing costs and transportation costs occurs.

Additionally, the organic acid compositions described herein can reduce precipitates formed in the surfactant compositions, thereby reducing a viscosity of the surfactant compositions, and increasing the flowability of the surfactant compositions. For example, one or more precipitates in the surfactant compositions can include sodium digycolate, which may form in the surfactant compositions as a manufacturing process byproduct. The organic acids can undergo salt-metathesis, thereby forming diglycolic acid and a sodiated carboxylate, and increasing solubility of the precipitate. Additionally, or alternatively, the organic acids can increase polarity of the surfactant composition, thereby enhancing the solubility of the precipitate to prevent precipitation. Additionally, or alternatively, the organic acids, having a low polarity surfactant phase, can allow water and/or an aqueous phase to dissolve the one or more precipitates, thereby reducing a turbidity of the surfactant composition and increase the flowability of the surfactant composition.

Surfactant compositions described herein remain continuous at temperatures above −15° C. These surfactant compositions include alkyl ether carboxylate anions to stabilize the oil-water interface. The anions can be obtained by adding acids to the saline aqueous phase along with a basic neutralizing reagent or material such as NaOH, triethyl amine, lime, or soda ash (a source of NaOH). For example, alkyl ether carboxylic acids can be added to a saturated NaCl solution to generate alkyl ether anions, with sodium hydroxide to control pH.

### Drilling Fluid

The drilling fluid of the present disclosure includes an emulsion. The emulsion includes a direct emulsion drilling fluid having an aqueous phase and an oil. The aqueous phase includes water, brine, ionic solutions, or a combination thereof. The aqueous phase can include pure water, brine up to saturation, ionic solutions, or a combination thereof. The aqueous phase can include alkali metal halide salts, alkali metal salts with small organic anions, and alkali metal salts with inorganic anions such as sulfate, phosphate, and nitrate. Without being bound by theory, a saturated brine can minimize formation damage when drilling through salt-containing formations, but the salinity of the aqueous mixture used for the drilling fluid emulsion can be adjusted, or pure water can be used in some cases.

An oil is dispersed within the aqueous phase as an emulsion. Additionally, a surfactant composition is dispersed within the emulsion, thereby stabilizing the oil and aqueous phase to maintain a dispersion. The surfactant composition includes an alkyl ether anion. The alkyl ether anion has an alkyl end portion, which may include functional groups, an ether middle portion, which may include functional groups, and an anionic head group, where the ether middle portion is between the anionic head group and the alkyl end portion. The alkyl portion of the alkyl ether anions provides micellar affinity to the oil to maintain the oil-in-water emulsion. Longer and/or larger alkyl end portions increase the micellar affinity to the oil phase, reducing tendency of the mixture to foam.

The alkyl ether carboxylate anions used herein can be tuned. In one aspect, the length of the ether chain, and type of repeating units in the ether chain, can be selected to deliver desired properties of the surfactant composition, e.g., stability, foaming characteristic, and a combination thereof. For example, the polymerization reaction of an alkylene oxide with an acid-terminating species, such as amide, can be performed with a targeted excess of alkylene oxide to yield an alkyl polyether anion species with a desired polyether chain length. Also, the polyether reaction can be performed using a mixture of alkylene oxides or with sequentially added aliquots of different alkylene oxides to yield random or block alkyl polyether chains terminated with carboxylate functionality.

In another aspect, the polyether chain can be functionalized by making the alkyl polyether anions using functionalized alkylene oxides. Functionalities that can be added to the alkylene oxide portions of the alkyl polyether anions include methyl groups, ethyl groups, propyl groups, ethers, alcohols, carboxylic acids, sulfonates, and phosphates.

The alkyl portion of the alkyl ether anion can be linear or branched, and can include unsaturation in carbon-carbon bonds in the main alkyl chain, to the extent there is a main alkyl chain, or in branches from the main alkyl chain. The alkyl portion can be linear, or can have up to two branches, which may branch from the same carbon atom or from different carbon atoms. The alkyl portion can be entirely saturated hydrocarbyl units, or can include up to two carbon-carbon double bonds, which can be anywhere in the main alkyl chain or in a branch. Two carbon-carbon double bonds can include the same carbon atom (i.e. a CH═C═CH structure), or two carbon-carbon double bonds can be between two different neighboring pairs of carbon atoms. The alkyl portion can also include only one carbon-carbon double bond. The alkyl portion can also include functional groups along the main chain, or any branches, and the functional groups can include alcohol-containing groups or ether or polyether groups. The alkyl portion can be a linear hydrocarbyl structure, with up to two branches and up to two carbon-carbon double bonds, which can have pendant hydroxyl groups and/or oxygen incorporated as an ether structure at any location in the alkyl portion. This structure of the alkyl portion provides an oil-compatible structure that will intimately interact with oil molecules without forming self-aligning domains that reduce affinity of the alkyl portion with oil molecules. In this way, surfactant performance of the surfactant molecules in an emulsion of oil with an aqueous phase is maintained.

In some embodiments, which can be combined with other embodiments, the alkyl ether anion can include an oleth carboxylate. The oleth carboxylate can include a C₁₆-C₁₈ alkyl end portion, a C₁-C₃ ether middle portion, and a carboxylate anionic head group. The C₁₆-C₁₈ can include one or more of a palmitic alkyl chain, palmitoleic alkyl chain, sapienic alkyl chain, α-linolenic alkyl chain, stearidonic alkyl chain, linoleic acid, linolelaidic alkyl chain, γ-linolenic alkyl chain, vaccenic alkyl chain, paullinic alkyl chain, oleic alkyl chain, elaidic alkyl chain, a margaric alkyl chain, or a combination thereof. For example, the C16-C18 alkyl end portion can include an oleic alkyl chain as the alkyl end portion. In some embodiments, which can be combined with the other embodiments, the oleth carboxylate can include an iodine value, e.g., a value representing the unsaturated averaged over all the molecules of the alkyl ether anion, of about 60 to about 100. In some embodiments, the alkyl ether anion is selected from the group consisting of oleth-9 carboxylate, an oleth-10 carboxylate, an oleth-11 carboxylate, an oleth-12 carboxylate, an oleth-13 carboxylate, or a combination thereof.

The surfactant composition includes an organic acid composition including a carboxylic acid. The carboxylic acid can include a molecular weight of about 45 g/mol to about 1,000 g/mol, e.g., 45 g/mol to about 150 g/mol. The carboxylic acid can include a carboxylic acid including a substituted C₁-C₈ carboxylic acid, an unsubstituted C₁-C₈ carboxylic acid, or combinations thereof. For example, the carboxylic acid can be selected from the group consisting of acetic acid, formic acid, 2-ethylhexanoic acid, propionic acid, and benzoic acid. As a further example, the carboxylic acid can include formic acid. Without being bound by theory, the organic acid composition can include a boiling point that is greater than conventional pour point additives, e.g., aromatic solvents, thereby reducing and/or preventing vapor off gassing, and increasing safety.

The carboxylic acid can be represented by Formula (I):

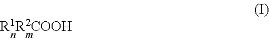

wherein R¹ is selected from the group consisting of a substituted C₁-C₈ alkyl, an unsubstituted C₁-C₈ alkyl, a substituted C₁-C₈ alkylene, an unsubstituted C₁-C₈ alkylene, substituted C₁-C₈ alkynl, an unsubstituted C₁-C₈ alkynl, substituted C₁-C₈ alkynlene, an unsubstituted C₁-C₈ alkynlene, substituted C₁-C₈ aryl, an unsubstituted C₁-C₈ aryl, a substituted C₁-C₈ alkoxy, an unsubstituted C₁-C₈ alkoxy, and combinations thereof; R² is a substituted C₁-C₃ alkoxy or unsubstituted C₁-C₃ alkoxy; n is an integer of 1 to 5; and m is an integer of 1 to 5. In some embodiments, R¹ can be C₁-C₈ unsubstituted alkylene, n can be 1, m can be 2, R² can be an unsubstituted C₁-C₃ alkoxy, and m can be 2. In some embodiments, R¹ can be C₁-C₈ unsubstituted alkylene, n can be 1, m can be 2, R² can be an unsubstituted C₁-C₃ alkoxy, and m can be 3. For example, the organic acid composition can include buteth-2-carboxylic acid or buteth-3-carboxylic acid.

Without being bound by theory, the organic acid compositions of the present disclosure can form one or more dimers and/or trimers with the anionic head group of the alkyl ether anion via two or more hydrogen bonds. The one or more dimers and/or trimers can reduce the pour point of the alkyl ether anions without destabilizing the surfactant composition.

In some embodiments, the organic acid composition comprises a mixture of the organic acid, e.g., carboxylic acid, and water. For example, the organic acid composition can include a mixture having a ratio of organic acid to water of about 60:40 vol % to about 99:1 vol %, e.g., about 70:30 vol % to about 99:1 vol % of the organic acid to the water, about 80:20 vol % to about 99:1 vol % of the organic acid to the water, or about 90:10 vol % to about 99:1 vol % of the organic acid to the water.

The organic acid composition described herein can be added or supplemented as esters that can hydrolyze in the drilling fluid under conditions experienced in a well to yield the organic acids described herein. Thus, a C₁-C₅ alkyl and a C₁-C₃ alkyoxy can be added to a drilling fluid mixture to yield a stable emulsion when downhole conditions promote hydrolysis of the ether to form the organic acid. Additionally, or alternatively, a C₁-C₅ alkyoxy can be added to a drilling fluid mixture to yield a stable emulsion when downhole conditions promote hydrolysis of the ether to form the organic acid.

In some embodiments, the surfactant composition includes a ratio of about 50:50 vol % to about 95:5 vol % of the alkyl ether anion surfactant to the organic acid composition, e.g., about 60:40 vol % to about 95:5 vol % of the alkyl ether anion surfactant to the organic acid composition, about 80:20 vol % to about 95:5 vol % of the alkyl ether anion surfactant to the organic acid composition, or about 90:10 vol % to about 95:5 vol % of the alkyl ether anion surfactant to the organic acid composition. Without being bound by theory, the surfactant composition having a ratio of about 50:50 vol % to about 95:5 vol % of the alkyl ether anion surfactant to the organic acid composition can allow for a reduced amount of dilution of the alkyl ether anion surfactant, thereby reducing manufacturing costs and transportation costs.

In some embodiments, the surfactant composition includes a pour point of about −15° C. to about 0° C., e.g., about −15° C. to about −5° C., about −15° C. to about −6° C., or about −11° C. to about −9° C. The surfactant composition can include a stability of about 6 hours to about 48 hours, or more, at a temperature of about −15° C. to about 0° C., e.g., about 12 hours to about 500 hours, about 24 hours to about 200 hours, or about 36 hours to about 100 hours. Without being bound by theory, the surfactant composition having a stability of about 6 hours to about 48 hours, or more, at a temperature of about −15° C. to about 0° C. can allow for flowability of the surfactant composition and/or the drilling fluid at reduced temperatures compared to conventional surfactant compositions and/or drilling fluids.

The drilling fluid emulsified mixtures described can include 70-80% brine, 20-30% oil, such as diesel oil, base oil, or other oils suitable for use in drilling fluid emulsions, and 5-10% one or more of the surfactant compositions described herein. The brine can be unsaturated, and can contain other alkali metal salts, such as lithium and potassium salts, for example LiCl and KCl. Anions in the brine can also include other halogens, other inorganic anions such as sulfate, phosphate, and nitrate, and small organic anions such as acetate and citrate. A basic material such as NaOH, LiOH, or KOH, or an amine base, can be added to control pH.

The drilling fluids can include one or more alkaline agents. The one or more alkaline agents are generally strong bases configured to maintain the surfactant species herein in anionic form to stabilize the phase interface of the emulsion. The alkaline agent can be classified as a hard base, Lewis base, or any other alkaline molecule that ionizes in water and deprotonates an acidic oxygen-based moiety or molecular group. For example, a hard base can promote the surfactant species to remain in anion form. In some embodiments, the alkaline agents can include hydroxide bases, e.g., calcium hydroxide, amine bases, e.g., unsaturated amine bases, lime, or a combination thereof.

In some embodiments, the drilling fluids described herein can prevent unwanted emulsion responses, such as foaming and creaming. For example, one or more additives can be added to the drilling fluids. The additives can include one or more long chain alkyl components to increase pour point and decrease flash point of the surfactant composition to an undesirable degree. The additives can include one or more aromatic and non-aromatic solvents such as toluene, xylene, Aromatic 150, and Aromatic 200, alcohols, and glycol such as hexyl CARBITOL™ and hexyl CELLOSOLVE™ to increase flash point and lower pour point of the surfactant composition. While the surfactant anions described herein generally can be selected to minimize foaming, in some cases the surfactant anions described herein can be used with defoaming agents such as DEFOAM X™ available from Schlumberger Ltd. of Houston, TX. Other types of defoaming agent chemistry that are compatible with this surfactant can include silicones, silanes, alcohols, and glycols. For example, a defoaming agents can include 2-ethylhexanol and propylene glycol. Viscosifying agents known in the art can also be used in the drilling fluids and surfactant packages described herein.

### EXAMPLES

### Example 1

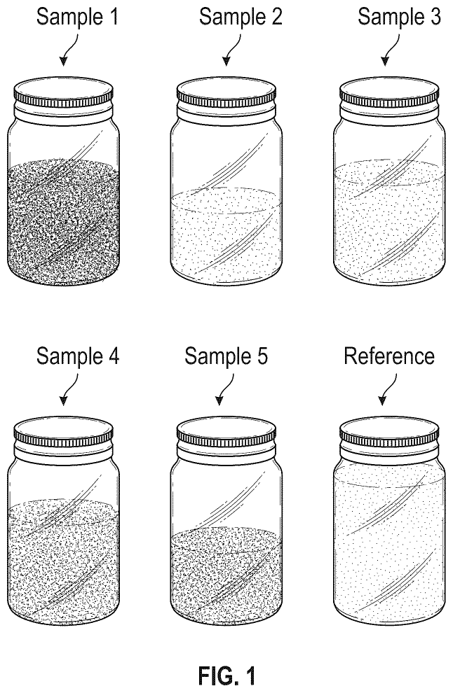

Now referring to FIG. 1, surfactant compositions including an alkyl ether anion surfactant, e.g., oleth-9 carboxylate, and a first organic acid, e.g., ethylhexeth-5-carboxylic acid, or a second organic acid buteth-2-carboxylic acid were prepared by blending 50:50 wt %, 75:25 wt %, and 85:15 wt % of the alkyl ether anion surfactant and the first organic acid or the alkyl ether anion surfactant and the second organic action. A reference surfactant composition having only the alkyl ether anion was also prepared.

Each of sample 1 (85:15 wt % alkyl ether anion surfactant and second organic acid), sample 2 (75:25 wt % alkyl ether anion surfactant and second organic acid), sample 3 (50:50 wt % alkyl ether anion surfactant and second organic acid), example 4 (50:50 wt % alkyl ether anion surfactant and second organic acid), and sample 5 (75:25 wt % alkyl ether anion surfactant and second organic acid), were stored in an ice water cooler for 16 hours. The reference solidified and was unable to flow. Each of samples 1, 2, 3, 4, and 5 remained fluid having either a clear and/or hazy appearance.

Samples 2 and 3 remained clear in appearance, while samples 4 and 5 became hazy had an increased viscosity, thereby indicating that the second organic acid was more effective at reducing pour point and maintaining stability at the traduced pour point. Additionally, sample 1 remained fluid at the lower temperature, having a higher viscosity than sample 5. Without being bound by theory, sample 1 having the lowest concentration of the organic acid may allow for an increased concentration of the alkyl ether anion surfactant, thereby reducing manufacturing costs and increasing stabilization of the emulsion.

Without being bound by theory, due to the similar chemical groups of the alkyl ether anion surfactant and the second organic acid, a reduced and/or eliminated likelihood of cross reactivity in the surfactant composition occurs compared to conventional pour point reduction additives such as alcohols.

### Example 2

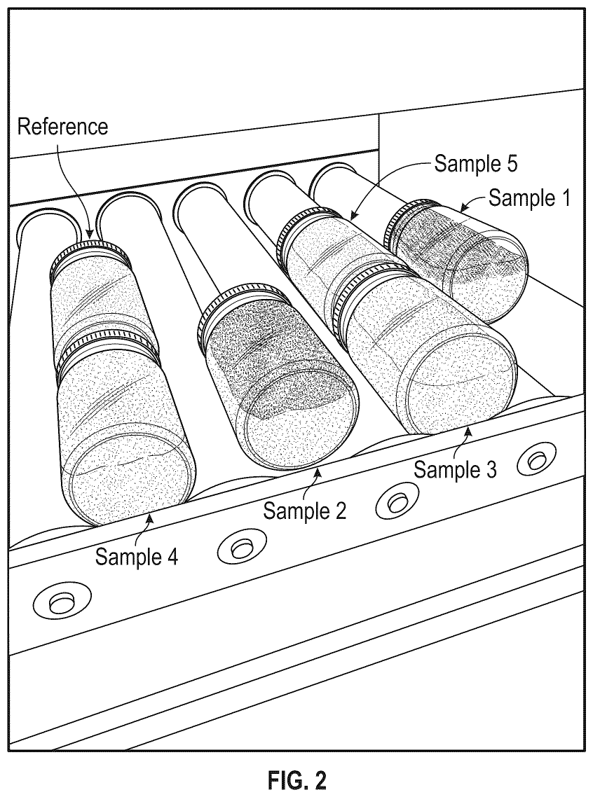

Now referring to FIG. 2, drilling fluids including 70:30 vol % of saturated NaCl brine and diesel were prepared. The drilling fluids included 6 grams of the surfactant composition having a 50:50 wt % of the alkyl ether anion surfactant, e.g., oleth-9 carboxylate, and the first organic acid, e.g., ethylhexeth-5-carboxylic acid, (Sample 1), 75:25 wt % of the alkyl ether anion surfactant and the first organic (Sample 2), 50:50 wt % of the alkyl ether anion surfactant and the second organic acid, e.g., buteth-2-carboxylic acid, (Sample 3), or 75:25 wt % of the alkyl ether anion surfactant and the second organic acid (Sample 4). A reference drilling fluid was prepared having a surfactant including only the alkyl ether anion was also prepared. 2 grams of calcium hydroxide were added to the drilling fluid. The drilling fluids were sheared on a silverson shearing apparatus for 5 minutes at 7,000 revolutions per minute, and placed in an oven at 150° F. while rolling. The samples were incubated for 3 hours with rolling.

Samples 1 and 2 separated after incubation, thereby indicating de-stabilization of the drilling fluids. The reference drilling fluid, sample 3, and sample 4 remained stable after the 3 hours, thereby indicating compatibility of the second organic acid with the drilling fluid.

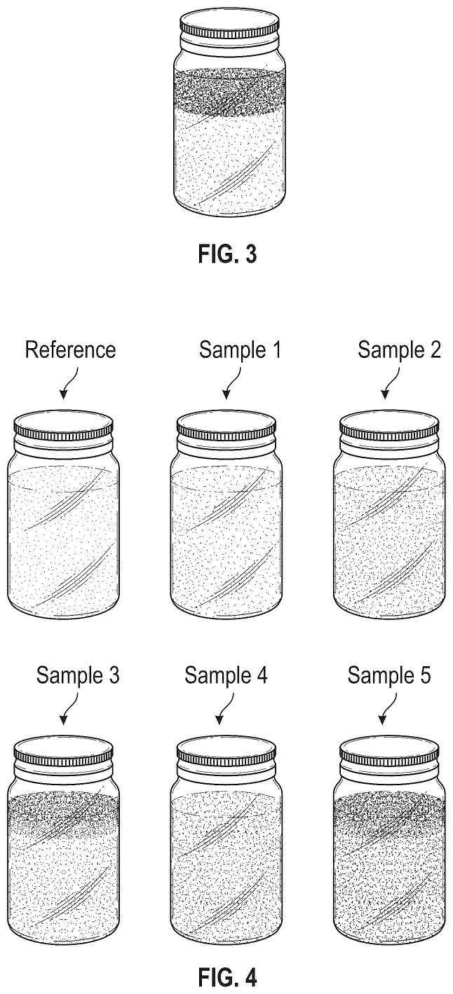

Now referring to FIG. 3, a drilling fluid having a surfactant composition including only the second organic acid was prepared. The drilling fluid included a reduced pour point, but separated after incubation for 3 hours with rolling, thereby indicating reduced and/or eliminated emulsifier capabilities of the second organic acid when using only the second organic acid as the surfactant composition.

### Example 3

Now referring to FIG. 4, drilling fluids including 70:30 vol % of saturated NaCl brine and diesel were prepared. The drilling fluids included 6 grams of the surfactant composition having a 85:15 wt % of the alkyl ether anion surfactant, e.g., oleth-9 carboxylate, and the second organic acid, e.g., buteth-2-carboxylic acid, (Example 1), 75:25 wt % of the alkyl ether anion surfactant and the second organic acid (Example 2), 50:50 wt % of the alkyl ether anion surfactant and the second organic acid (Example 3), 75:25 wt % of the alkyl ether anion surfactant and the first organic acid, e.g., ethylhexeth-5-carboxylic acid, (Example 4), and 50:50 wt % of the alkyl ether anion surfactant and the first organic acid (Example 5). A reference drilling fluid was prepared having a surfactant including only the alkyl ether anion was also prepared. 2 grams of calcium hydroxide were added to the drilling fluid. The drilling fluids were sheared on a silverson shearing apparatus for 5 minutes at 7,000 revolutions per minute, and placed in an oven at 150° F. while rolling. The samples were incubated for 48 hours with rolling.

Examples 3 and 5 started separating after incubation for 48 hours, thereby indicating the start of a de-stabilization of the drilling fluids. The reference drilling fluid, example 1, example 2, and example 4 remained stable after the 48 hours, thereby indicating emulsion stability and the organic acid, e.g., pour point additive, did not destabilize the drilling fluid.

### Example 4

Surfactant compositions including an alkyl ether anion surfactant, e.g., oleth-9 carboxylate, and one or more of an organic acid having a molecular weight of less than 150 g/mol were prepared by blending 75:25 wt % of the alkyl ether anion surfactant and the one or more of an organic acid having a molecular weight of less than 150 g/mol. The one or more of an organic acid having a molecular weight of less than 150 g/mol included acetic acid, 88% formic acid in water, 2-ethylhexanoic acid, propionic acid, benzoic acid, and hydrochloric acid.

The surfactant composition including 75:25 wt % of the alkyl ether anion surfactant and benzoic acid resulted in solidification of the surfactant composition. The other remaining organic acids remained liquid after being stored in an ice water cooler for 16 hours. Without being bound by theory, the surfactant composition including 75:25 wt % of the alkyl ether anion surfactant and acetic acid may remain liquid and thin at 0° C. due to the formation of dimers and/or trimers between the acetic acid and the alkyl ether anion surfactant. Additionally, and without being bound by theory, an increase in stabilization can occur as the molecular weight of the organic acid reduces, thereby allowing for more dimer and/or trimer interactions to occur.

Without being bound by theory, the use of one or more organic acids having a molecular weight of less than 150 g/mol can reduce vapor pressures of the drilling fluid, thereby reducing volatility and/or odor of the drilling fluid. Additionally, and without being bound by theory, higher molecular weight organic acids, e.g., organic acids having a molecular weight of about 100 g/mol to about 150 g/mol, will reduce vapor pressures greater than lower molecular weight organic acids, e.g., organic acids having a molecular weight of about 40 g/mol to about 100 g/mol. Additionally, and without being bound by theory, higher molecular weight organic acids, e.g., organic acids having a molecular weight of about 100 g/mol to about 150 g/mol, will reduce pour points of the surfactant compositions less than lower molecular weight organic acids, e.g., organic acids having a molecular weight of about 40 g/mol to about 100 g/mol.

The surfactant composition including 75:25 wt % of the alkyl ether anion surfactant and hydrochloric acid resulted in solidification of the surfactant composition, thereby indicating a lack of pour point reduction. Additionally, surfactant compositions including organic acid salts did not result in a pour point reduction.

### Example 5

Long term stability of the drilling fluid was performed. A reference surfactant composition having only an alkyl ether anion surfactant, e.g., oleth-9 carboxylate, was compared to surfactant compositions having 80 wt % of alkyl ether anion surfactant, e.g., oleth-9 carboxylate, and 20 wt % of the second organic acid, e.g., buteth-2-carboxylic acid, (Sample 1), 80 wt % of alkyl ether anion surfactant, e.g., oleth-9 carboxylate, 10 wt % of the second organic acid, e.g., buteth-2-carboxylic acid, and 10 wt % of water (Sample 2), and 90 wt % of alkyl ether anion surfactant, e.g., oleth-9 carboxylate, 5 wt % of a third organic acid, and 5 wt % of water (Sample 3). The third organic acid included 88% formic acid in water, as shown in Table 1.

TABLE 1

| Surfactant Composition | Pour Point Limit |
|---|---|
| Reference | 18° C. |
| Example 1 | −9° C. |
| Example 2 | −11° C. |
| Example 3 | −9° C. |

Each of the surfactant compositions examples resulted in a pour point limit of less than 0° C. target. After storage at 0° C. for 16 hours, the reference surfactant composition solidified, in which the reference surfactant solidified in only 30 minutes after the initial storage. After storage at 0° C. for 16 hours, examples 1-3, remained liquid and transparent even, thereby indicating long term storage capabilities at lower temperatures compared to the reference surfactant compositions.

Without being bound by theory, the organic acid can include a mixture of an organic acid and water, thereby allowing for a reduction manufacturing costs due to reduced organic acid being used. Moreover, and without being bound by theory, an organic acid including a mixture of organic acid and water can reduce the amount of organic acid in the vapor phase, thereby increasing safety.

The surfactant compositions described herein include favorable fluid properties that remain stable or partially stable in reduced temperature, e.g., below 0° C., conditions. Generally, a surfactant composition as described herein is obtained and added to a mixture of a base oil and an aqueous phase that can be pure water or can contain alkali salts, and up to a low level of alkaline earth salts, to form a drilling fluid mixture. The drilling fluid mixture is then subjected to high-shear agitation to form an emulsion. The resulting drilling fluid emulsion is then used to perform a drilling operation.

### Enumerated Embodiments

E1. A drilling fluid comprising an emulsion, the emulsion comprising an aqueous phase; an oil; and a surfactant composition comprising an alkyl ether anion surfactant comprising an oleth carboxylate; and an organic acid composition comprising a carboxylic acid.
E2. The drilling fluid of embodiment E1, wherein the oleth carboxylate is selected from the group consisting of an oleth-9 carboxylate, an oleth-10 carboxylate, an oleth-11 carboxylate, an oleth-12 carboxylate, an oleth-13 carboxylate, or a combination thereof.
E3. The drilling fluid of embodiments E1 or E2, wherein the carboxylic acid comprises a molecular weight of about 45 g/mol to about 150 g/mol.
E4. The drilling fluid of any one of embodiments E1-E3, wherein the carboxylic acid comprises a substituted C₁-C₈ carboxylic acid, an unsubstituted C₁-C₈ carboxylic acid, or combinations thereof.
E5. The drilling fluid of embodiment E4, wherein the carboxylic acid is selected from the group consisting of acetic acid, formic acid, 2-ethylhexanoic acid, propionic acid, and benzoic acid.
E6. The drilling fluid of any one of embodiments E1-E5, wherein the carboxylic acid comprises is represented by Formula (I): Rₙ¹Rₘ²COOH (I) wherein R¹ is selected from the group consisting of a substituted C₁-C₈ alkyl, an unsubstituted C₁-C₈ alkyl, a substituted C₁-C₈ alkylene, an unsubstituted C₁-C₈ alkylene, substituted C₁-C₈ alkynl, an unsubstituted C₁-C₈ alkynl, substituted C₁-C₈ alkynlene, an unsubstituted C₁-C₈ alkynlene, substituted C₁-C₈ aryl, an unsubstituted C₁-C₈ aryl, a substituted C₁-C₈ alkoxy, an unsubstituted C₁-C₈ alkoxy, and combinations thereof; R² is an C₁-C₃ alkoxy; n is an integer of 1 to 5; and m is an integer of 1 to 5.
E7. The drilling fluid of embodiment E6, wherein the carboxylic acid comprises a buteth-2-carboxylic acid or buteth-3-carboxylic acid.
E8. The drilling fluid of any one of embodiments E1-E7, wherein the organic acid composition further comprises a mixture of an organic acid and water.
E9. The drilling fluid of embodiment E8, wherein the surfactant composition comprises a ratio of about 50:50 vol % to about 95:5 vol % of the alkyl ether anion surfactant to the organic acid composition.
E10. The drilling fluid of any one of embodiments E1-E9, wherein the surfactant composition comprises a stability of about 6 hours to about 48 hours at a temperature of about −15° C. to about 0° C.
E11. The drilling fluid of any one of embodiments E1-E10, further comprising a glycol, an alcohol, an aromatic solvent, a non-aromatic solvent, or a combination thereof.
E12. The drilling fluid of any one of embodiments E1-E11, further comprising a defoaming agent.
E13. The drilling fluid of any one of embodiments E1-E12, further comprising a viscosifying agent.
E14. The drilling fluid of any one of embodiments E1-E13, further comprising an alkaline agent.
E15. The drilling fluid of any one of embodiments E1-E14, wherein the aqueous phase comprises a brine.
E16. A surfactant composition, the surfactant composition comprising an alkyl ether anion surfactant comprising an oleth carboxylate; and an organic acid composition comprising an organic acid represented by Formula (I): Rₙ¹Rₘ²COOH (I) wherein R¹ is selected from the group consisting of a substituted C₁-C₈ alkyl, an unsubstituted C₁-C₈ alkyl, a substituted C₁-C₈ alkylene, an unsubstituted C₁-C₈ alkylene, substituted C₁-C₈ alkynl, an unsubstituted C₁-C₈ alkynl, substituted C₁-C₈ alkynlene, an unsubstituted C₁-C₈ alkynlene, substituted C₁-C₈ aryl, an unsubstituted C₁-C₈ aryl, a substituted C₁-C₈ alkoxy, an unsubstituted C₁-C₈ alkoxy, and combinations thereof; R² is an C₁-C₃ alkoxy; n is an integer of 1 to 5; and m is an integer of 0 to 5.
E17. The surfactant composition of embodiment E16, wherein the oleth carboxylate comprises an iodine value of about 60 to about 100.
E18. The surfactant composition of embodiment E16 or E17, wherein the alkyl ether anion surfactant is selected from the group consisting of an oleth-9 carboxylate, an oleth-10 carboxylate, an oleth-11 carboxylate, an oleth-12 carboxylate, an oleth-13 carboxylate, or a combination thereof.
E19. The surfactant composition of any one of embodiments E16-E18, wherein the organic acid comprises a molecular weight of about 45 g/mol to about 150 g/mol.
E20. The surfactant composition of any one of embodiments E16-E19, wherein the organic acid is selected from the group consisting of acetic acid, formic acid, 2-ethylhexanoic acid, propionic acid, benzoic acid, buteth-2-carboxylic acid, buteth-3-carboxylic acid, and combinations thereof.
E21. The surfactant composition of any one of embodiments E16-E20, wherein the organic acid composition further comprises a mixture of the organic acid and water.
E22. The surfactant composition of embodiment E21, wherein the surfactant composition comprises a ratio of about 50:50 vol % to about 95:10 vol % of the alkyl ether anion surfactant to the organic acid composition.
E23. The surfactant composition of any one of embodiments E16-E22, wherein the surfactant composition comprises a stability of about 6 hours to about 48 hours at a temperature of about −15° C. to about 0° C.
E24. A method, comprising obtaining a drilling fluid comprising an emulsion of an oil dispersed within an aqueous phase, the emulsion stabilized using a surfactant composition comprising an alkyl ether anion surfactant; and an organic acid composition; and drilling a well into a geologic formation using the drilling fluid from a surface of a well through vertical sections and into lateral sections.
E25. The method of embodiment E24, wherein the alkyl ether anion surfactant is selected from the group consisting of an oleth-9 carboxylate, an oleth-10 carboxylate, an oleth-11 carboxylate, an oleth-12 carboxylate, an oleth-13 carboxylate, or a combination thereof.
E26. The method of embodiment E24 or E25, wherein the organic acid composition comprises an organic acid selected from the group consisting of acetic acid, formic acid, 2-ethylhexanoic acid, propionic acid, and benzoic acid, buteth-2-carboxylic acid, buteth-3-carboxylic acid, and combinations thereof.
E27. The method of embodiment E26, wherein the organic acid composition further comprises a mixture of the organic acid and water.
E28. The method of embodiment E27, wherein the surfactant composition comprises a ratio of about 50:50 vol % to about 95:10 vol % of the alkyl ether anion surfactant to the organic acid composition; and a stability of about 6 hours to about 48 hours at a temperature of about −15° C. to about 0° C.
E29. The method of any one of embodiments E24-E28, wherein the aqueous phase comprises brine.

Overall, the present disclosure provides direct emulsion drilling fluids having surfactant compositions including an organic acid compositions. The organic acid compositions include a reduced pour point of about −15° C. without destabilization of the surfactant compositions and without creating objectionable odors or introducing aromatic solvents. Moreover, the stability of the surfactant compositions may be maintained for a period of about 6 hours to about 48 hours, or more. Additionally, the organic acid compositions described herein can reduce precipitates formed in the surfactant compositions, thereby reducing a viscosity of the surfactant compositions, and increasing the flowability of the surfactant compositions.

While the foregoing is directed to embodiments of the present invention, other and further embodiments of the present disclosure may be devised without departing from the basic scope thereof, and the scope thereof is determined by the claims that follow.

What is claimed is:

1. A drilling fluid comprising an emulsion, the emulsion comprising:
an aqueous phase;
an oil; and
a surfactant composition comprising:
an alkyl ether anion surfactant comprising an oleth carboxylate; and
an organic acid composition comprising a carboxylic acid.

2. The drilling fluid of claim 1, wherein the carboxylic acid comprises a molecular weight of about 45 g/mol to about 150 g/mol.

3. The drilling fluid of claim 1, wherein the carboxylic acid comprises a substituted C₁-C₈ carboxylic acid, an unsubstituted C₁-C₈ carboxylic acid, or combinations thereof.

4. The drilling fluid of claim 3, wherein the carboxylic acid is selected from the group consisting of acetic acid, formic acid, 2-ethylhexanoic acid, propionic acid, and benzoic acid.

5. The drilling fluid of claim 1, wherein the carboxylic acid comprises is represented by Formula (I): 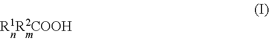
wherein R¹ is selected from the group consisting of a substituted C₁-C₈ alkyl, an unsubstituted C₁-C₈ alkyl, a substituted C₁-C₈ alkylene, an unsubstituted C₁-C₈ alkylene, substituted C₁-C₈ alkynl, an unsubstituted C₁-C₈ alkynl, substituted C₁-C₈ alkynlene, an unsubstituted C₁-C₈ alkynlene, substituted C₁-C₈ aryl, an unsubstituted C₁-C₈ aryl, a substituted C₁-C₈ alkoxy, an unsubstituted C₁-C₈ alkoxy, and combinations thereof;
R² is an C₁-C₃ alkoxy;
n is an integer of 1 to 5; and
m is an integer of 1 to 5.

6. The drilling fluid of claim 5, wherein the carboxylic acid comprises a buteth-2-carboxylic acid or buteth-3-carboxylic acid.

7. The drilling fluid of claim 1, wherein the organic acid composition further comprises a mixture of an organic acid and water.

8. The drilling fluid of claim 7, wherein the surfactant composition comprises a ratio of about 50:50 vol % to about 95:5 vol % of the alkyl ether anion surfactant to the organic acid composition.

9. The drilling fluid of claim 1, wherein the surfactant composition comprises a stability of about 6 hours to about 48 hours at a temperature of about −15° C. to about 0° C.

10. A surfactant composition, the surfactant composition comprising:
an alkyl ether anion surfactant comprising an oleth carboxylate; and
an organic acid composition comprising an organic acid represented by Formula (I): 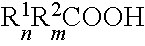
wherein R¹ is selected from the group consisting of a substituted (I) alkyl, an unsubstituted C₁-C₈ alkyl, a substituted C₁-C₈ alkylene, an unsubstituted C₁-C₈ alkylene, substituted C₁-C₈ alkynl, an unsubstituted C₁-C₈ alkynl, substituted C₁-C₈ alkynlene, an unsubstituted C₁-C₈ alkynlene, substituted C₁-C₈ aryl, an unsubstituted C₁-C₈ aryl, a substituted C₁-C₈ alkoxy, an unsubstituted C₁-C₈ alkoxy, and combinations thereof;
R² is an C₁-C₃ alkoxy;
n is an integer of 1 to 5; and
m is an integer of 0 to 5.

11. The surfactant composition of claim 10, wherein the organic acid comprises a molecular weight of about 45 g/mol to about 150 g/mol.

12. The surfactant composition of claim 10, wherein the organic acid is selected from the group consisting of acetic acid, formic acid, 2-ethylhexanoic acid, propionic acid, benzoic acid, buteth-2-carboxylic acid, buteth-3-carboxylic acid, and combinations thereof.

13. The surfactant composition of claim 10, wherein the organic acid composition further comprises a mixture of the organic acid and water.

14. The surfactant composition of claim 13, wherein the surfactant composition comprises a ratio of about 50:50 vol % to about 95:10 vol % of the alkyl ether anion surfactant to the organic acid composition.

15. The surfactant composition of claim 10, wherein the surfactant composition comprises a stability of about 6 hours to about 48 hours at a temperature of about −15° C. to about 0° C.

16. A method, comprising:
obtaining a drilling fluid comprising an emulsion of an oil dispersed within an aqueous phase, the emulsion stabilized using a surfactant composition comprising:
an alkyl ether anion surfactant; and
an organic acid composition; and
drilling a well into a geologic formation using the drilling fluid from a surface of the well through vertical sections and into lateral sections.

17. The method of claim 16, wherein the alkyl ether anion surfactant is selected from the group consisting of an oleth-9 carboxylate, an oleth-10 carboxylate, an oleth-11 carboxylate, an oleth-12 carboxylate, an oleth-13 carboxylate, or a combination thereof.

18. The method of claim 16, wherein the organic acid composition comprises an organic acid selected from the group consisting of acetic acid, formic acid, 2-ethylhexanoic acid, propionic acid, and benzoic acid, buteth-2-carboxylic acid, buteth-3-carboxylic acid, and combinations thereof.

19. The method of claim 18, wherein the organic acid composition further comprises a mixture of the organic acid and water.

20. The method of claim 19, wherein the surfactant composition comprises:
a ratio of about 50:50 vol % to about 95:10 vol % of the alkyl ether anion surfactant to the organic acid composition; and
a stability of about 6 hours to about 48 hours at a temperature of about −15° C. to about 0° C.
